(19) United States
(12) Patent Application Publication
(10) Pub. No.: US 2009/0083736 A1
(43) Pub. Date: Mar. 26, 2009

(54) VIRTUALIZED COMPUTER, MONITORING METHOD OF THE VIRTUALIZED COMPUTER AND A COMPUTER READABLE MEDIUM THEREOF

(76) Inventor: SHINOBU GOTO, Tokyo (JP)

Correspondence Address: NEC CORPORATION OF AMERICA, 6535 N. STATE HWY 161, IRVING, TX, 75039, US

(21) Appl. No.: 12/234,356

(22) Filed: Sep. 19, 2008

(30) Foreign Application Priority Data
Sep. 25, 2007 (JP) 247801/2007

(51) Int. Cl. G06F 9/455

(52) U.S. Cl. 718/1

(57) ABSTRACT

A virtualized computer includes a CPU which shifts between a host mode and a guest mode. The CPU shifts executes either a guest OS or a virtual machine monitor (VMM) in the guest mode and executes a virtual machine monitor-monitor (VMMM) in the host mode. The VMM monitors the guest OS and the VMMM monitors the VMM.

This application is based upon and claims the benefit of priority from Japanese patent application No. 2007-247801, filed on Sep. 25, 2007, the disclosure of which is incorporated herein in its entirety by reference.

### BACKGROUND OF THE INVENTION

The present invention relates to virtualized computer, and more particularly to technology for further virtualizing a virtual machine monitor.

Computer virtualization technology is technology for building a virtual computer (Virtual Machine) by software on the operating system (OS) of a computer. Related virtualization technology builds a virtual machine by operating software called a Virtual Machine Monitor (VMM) on the host OS of the computer, and installs and operates application software and a guest OS on this assembled virtual machine. However this method places a large load on the hardware such as host OS and the central processing unit(CPU), etc.

Recently technology has become known for making the CPU and adjacent hardware execute a portion of the processing which the virtual machine monitor usually is executing. This method effectively achieves computer virtualization. This type of technology is called a virtualization support function. More specifically, technology such as “Intel®Virtualization Technology (Intel®VT)” by Intel Corp. USA and “AMD Virtualization Technology™ (AMD-V™)” by Advanced Micro Devices USA (AMD) is known. Here, instead of the host OS, a CPU containing the virtualization support function directly operates the virtual machine monitor, and the virtual machine monitor controls the virtual machine, and arbitrates (manages) the hardware resources, etc. This type of virtual machine monitor is called a Hypervisor.

The CPU containing the virtualization support function possesses the following functions for supporting the virtualization processing by the virtual machine monitor.

The CPU contains a two-stage virtualization privileged mode (privileged operating mode dedicated to virtualization) including a guest mode for operating the guest OS, and the host mode for operating the virtual machine monitor. Among all instructions implemented by the guest OS, the CPU stipulates instructions for executing commands required for virtualization (sensitive instructions). However the CPU also stipulates extended instructions for supporting the virtualization processing on the virtual machine monitor. These extended instructions are instructions exclusively for the virtual machine monitor, and are not executed by the guest OS. If these sensitive instructions or extended instructions are executed in the guest mode, then the CPU starts up exception processing (handling) and shifts to the host mode.

The CPU also possesses an area on a central storage device (RAM) for holding the state executed in each virtualization privileged mode. The CPU can utilize this central storage area to save or restore from the execution state during the virtualization privileged mode shifting (shifting between the guest mode and host mode). In this way, the contents processed in guest mode can be saved and the operation continued, even if the CPU shifts to host mode from the guest mode and then again restores the guest mode.

The examples of virtualization support technology are disclosed in following.

JP-T-2007-505402 discloses a virtual machine system for deciding which among multiple virtual machine monitors should process a special access event, and shifts control to that virtual machine monitor. JP-A-2005-56017 discloses a virtual machine system containing respective special access register sets for the host and the guest. JP-A-Hei02(1990)-187831 discloses a virtual machine system for starting an exception handling processor when the guest OS executes a special access instruction.

Applications which virtualize the virtual machine monitor even further are currently being considered. Such applications include applications for providing a test environment (system) for developing virtual machine monitors, applications for containing added value functions including security and Reliability Availability Serviceability (RAS) functions, and applications for simultaneously running multiple different virtual machine monitors on a single machine.

However the CPU described above contains only a two-stage virtualization privileged mode with a guest mode and host mode and so cannot handle applications which virtualize the virtual machine monitor even further. Even if further virtualization of the virtual machine monitor is attempted just by using software, the problem arises that a large load is placed on the hardware and the virtual machine monitor, the same as with virtualization technology that utilizes only software and does not use the virtualization support functions in the CPU.

JP-T-2007-505402 further virtualizes the virtual machine monitor but requires a special virtual machine monitor and a special hardware including a virtualization privileged mode of three or more stages in the CPU, etc. Even if combined with the technology disclosed in JP-A-2005-56017 and JP-A-Hei02 (1990)-187831, special hardware was still required for further virtualizing the virtual machine monitor.

### SUMMARY OF THE INVENTION

An exemplary object of the present invention is to provide a virtualized computer, a monitoring method of the virtualized computer and a computer readable medium thereof for further virtualizing the virtual machine monitor in a CPU containing only a two-stage virtualization privileged mode and that does not require a specific guest OS and specific virtual machine monitor.

According to one aspect of the present invention, a virtualized computer comprising: a CPU which shifts between a host mode and a guest mode, executing either a guest OS or a virtual machine monitor (VMM) in the guest mode and executing a virtual machine monitor-monitor (VMMM) in the host mode, wherein the VMM monitors the guest OS and the VMMM monitors the VMM.

According to one aspect of the present invention, a monitoring method of a virtualized computer which shifts between a host mode and a guest mode, comprising: executing either a guest OS or a virtual machine monitor (VMM) in the guest mode and executing a virtual machine monitor-monitor (VMMM) in the host mode, and the VMMM monitoring the VMM which monitors the guest OS.

According to one aspect of the present invention, a computer readable medium recording thereon a program for enabling a computer to execute a monitoring method of a virtualized computer which shifts between a host mode and a guest mode, the method comprising: executing either a guest OS or a virtual machine monitor (VMM) in the guest mode and executing a virtual machine monitor-monitor (VMMM) in the host mode, and the VMMM monitoring the VMM which monitors the guest OS.

According to one aspect of the present invention, a virtualized computer comprising: a means for shifting between a host mode and a guest mode, executing either a guest OS or a virtual machine monitor (VMM) in the guest mode and executing a virtual machine monitor-monitor (VMMM) in the host mode, wherein the VMM monitors the guest OS and the VMMM monitors the VMM.

### BRIEF DESCRIPTION OF THE DRAWINGS

Other features and advantages of the present invention will become apparent by the following detailed description and the accompanying drawings, wherein:

FIG. 1 is a block diagram showing the structure of the computer 10 of the first exemplary embodiment of this invention;

FIG. 2 is a block diagram showing the storage area in the main memory;

FIG. 3 is an overall concept view showing the structure of the software executed by the computer;

FIG. 4 is a flow chart showing the processing executed in the virtual machine monitor and the virtual machine monitor-monitor when an exception occurs by the guest OS executing a sensitive instruction;

FIG. 5 is a flow chart showing a continuation of FIG. 4;

FIGS. 6A, 6B and 6C are conceptual diagrams showing the execution state shifting in FIG. 4 and in FIG. 5; and

FIG. 7 is an overview diagram showing the structure of the software in the second exemplary embodiment.

FIG. 8 is an overall concept view showing the structure of the software in the case that main memory does not have virtualization support function control area and guest state save area in the first exemplary embodiment.

FIG. 9 is an overall concept view showing the structure of the software in the case that main memory does not have virtualization support function control area and guest state save area in the second exemplary embodiment.

In the drawings the same reference numerals represent the same structural elements.

### EXEMPLARY EMBODIMENT

A first exemplary embodiment of the present invention will be described in detail below.

### First Exemplary Embodiment

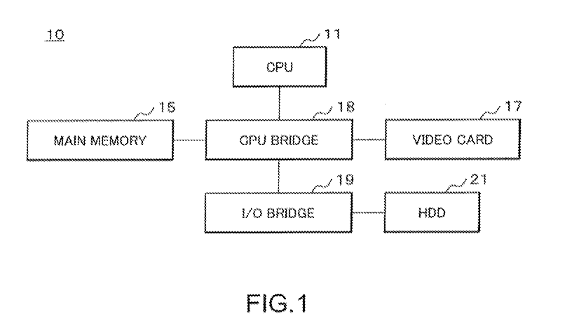

FIG. 1 is a block diagram showing the structure of a computer 10 in the first exemplary embodiment. A CPU 11 is a processing device for fulfilling the core functions of the computer 10, and executing the OS, Basic Input/Output System (BIOS), and application programs, etc. The CPU 11 handles virtualization support functions, and includes the two operating modes (virtualization privileged mode) called the guest mode and the host mode (described in detail later on). The CPU 11 is connected by way of an external bus to a chipset and sends and receives signals to each connected device. The chipset is made up of a CPU bridge 18 (north bridge) and an I/O bridge 19 (south bridge).

The CPU bridge 18 includes a memory controller function for controlling access to the main memory 15, and a data buffer function for absorbing the difference in data transfer speeds between the buses. The main memory 15 connects to the CPU bridge 18 and includes a writable memory capable of being utilized as the work area for writing the processing data, and a read area for the programs executed by the CPU 11. A video card 17 connects to the CPU bridge 18, receives draw instructions from the CPU 11, generates the required image, and shows the image on a display (not shown in drawings).

An I/O bridge 19 contains an IDE (Integrated Device Electronics) interface, a Universal Serial Bus(USB) interface, a Peripheral Component Interconnect (PCI) bus, and an Local Procedure Call (LPC) bus, etc. The I/O bridge 19 can connect to each peripheral circuit. An HDD (hard disk drive) 21 connects to the IDE interface. Each of the following software is installed in the HDD 21. The software are loaded and executed by the CPU 11.

In order to simplify the description for the first exemplary embodiment, FIG. 1 shows a simplified view of the main hardware elements and their related connections. Many other devices besides those shown here are used to contrive the computer 10. However these devices are known to those skilled in the art so a detailed description is not given. Moreover, a range selectable by one skilled in the art such as a simple Integrated Circuit(IC) circuit made up of multiple blocks as shown in FIG. 1 or conversely, one block subdivided into multiple integrated circuits are included in the range of the first exemplary embodiment.

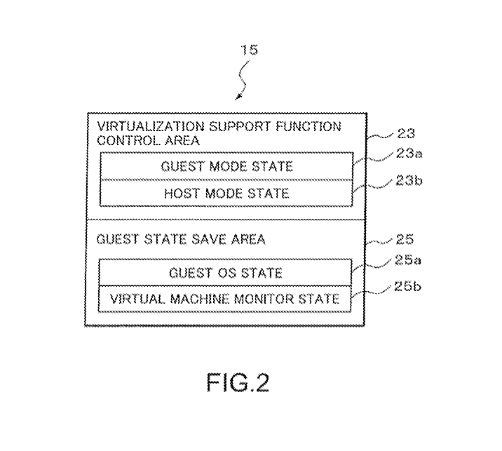

FIG. 2 is a block diagram showing the storage area provided in the main memory. The main memory 15 includes a virtualization support function control area 23 and a guest state save area 25.

The virtualization support function control area 23 is area provided in advance on the main memory 15 for controlling the actions when the CPU 11 is shifting between the guest mode and the host mode. The virtualization support function control area 23 includes a guest mode state 23a, and a host mode state 23b. This guest mode state 23a is a state executed when the CPU 11 is in guest mode. The host state 23b is a state executed when the CPU 11 is in the host mode. (Namely, the main memory 15 stores information indicating an execution state of the host mode and guest mode.)

The execution state of the guest mode 23a is retained unchanged when the CPU 11 shifts from guest mode to host mode, and the CPU 11 operates the execution state of host mode state 23b. The execution state of host mode state 23b is retained unchanged when the CPU 11 shifts from host mode to guest mode, and the CPU 11 operates the execution state of guest mode state 23a. The processing which accompanies the virtualization privileged mode shifting can be executed via CPU 11 as a hardware.

The guest state save area 25 is an area provided in the main memory 15 by software (virtual machine monitor-monitor 100 described later) operated in host mode for the purpose of saving the previous contents when multiple guest mode state 23a are rewritten. Locating the guest state save area 25 here allows the CPU 11 to store multiple execution states in the guest mode, and switch to execute a different state. The CPU 11 cannot simultaneously execute multiple execution states in the guest mode. Software operating in the host mode saves and restores an operating state.

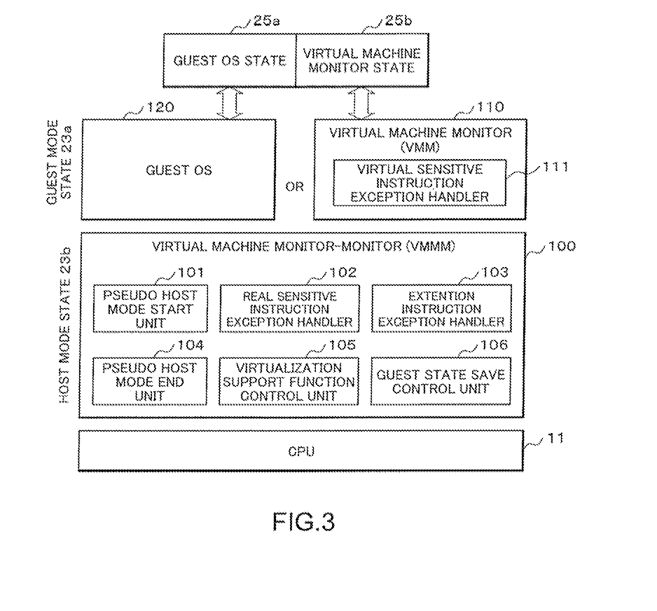

FIG. 3 is an overall concept view showing the structure of the software executed by the computer. In the first exemplary embodiment, the CPU 11 executes the virtual machine monitor-monitor (VMMM) 100 in the host mode, and executes either the VMM (VMM) 110 or the guest OS 120 in guest mode.

The host mode state 23b in main memory 15 constantly retains the execution state of the VMMM 100. The guest mode state 23a retains the execution state of either the VMM 110 or the guest OS 120 depending on the circumstances. The guest state save area 25 is made up of a guest OS state 25a for retaining the execution state of guest OS 120, and a virtual machine monitor state 25b for retaining the execution state of VMM 110. (Namely, the main memory 15 stores information indicating execution information of the guest OS 120 and VMM 110) The VMMM 100 controls switching of the operating between the VMM 110 and the guest OS 120 in the guest mode state 23a.

CPU 11 shifts to the host mode from the state which the VMM 110 is executed in guest mode, saves the execution state of VMM 110 in the virtual machine monitor state 25b, and by shifting the CPU 11 to the guest mode after restoring the execution state of guest OS 120 temporarily stored in the guest OS state 25a, the computer 10 can in guest mode shift the state where the guest OS 120 is executed. Moreover, by performing the above execution in reverse, the computer 10 can shift from the state where the guest OS 120 is executed to the state where the VMM 110 is executed.

In this way, it is realized that VMMM 100 further virtualizes (e.g., monitors) the state where VMM 110 controls(e.g., monitors) the guest OS 120. The guest OS 120 and the VMM 110 are all already in use and require no special modifications to implement the first exemplary embodiment. The VMM 110 is basically assumed to be executed in host mode, but in the first exemplary embodiment is executed in guest mode.

The VMM 110 is a program code for acquiring an exception which occurred by the guest OS 120 executing a sensitive instruction, and then performing the required virtualization processing. The VMM 110 includes a virtual sensitive instruction exception handler 111. This virtual sensitive instruction exception handler 111 can easily acquire the event generated by the guest OS 120 if the VMM 110 is executed in host mode. However, in the first exemplary embodiment, the VMM 110 is executed in guest mode, and further cannot be executed simultaneously with the guest OS 120.

Therefore, the VMMM 100 which always is executed in host mode captures the exception when generated by the guest OS 120 executing a sensitive instruction. The VMMM 100 then switches the execution state of the guest mode from the guest OS 120 to the VMM 110 and injects the captured exception into the VMM 110. In this way, the virtual sensitive instruction exception handler 111 can capture the exception generated by the guest OS 120.

The VMMM 100 includes a pseudo host mode start unit 101, a real sensitive instruction exception handler 102, an extension instruction exception handler 103, a pseudo host mode end unit 104, a virtualization support function control unit 105, and a guest state save control unit 106.

The pseudo host mode start unit 101 is a program code that performs the necessary pre-processing when an exception occurs due to the guest OS 120 executing a sensitive instruction, and then injects the virtualized exceptions into the VMM 110. The state where the VMM 110 is executed in guest mode is also called the pseudo host mode.

The real sensitive instruction exception handler 102 is a program code that captures exceptions occurring when the VMM 110 executes a sensitive command, and also performs the required virtualization processing. The actual processing contents of this program code are equivalent to the virtual sensitive instruction exception handler 111. However, though the sensitive instructions executed by the guest OS 120 are processed in the pseudo host mode and so are called virtual sensitive instructions, the sensitive instructions executed on the VMM 110 are processed by the actual host mode and so are called real sensitive instructions.

The extension instruction exception handler 103 is a program code that captures exceptions generated from the VMM 110 executing extension instructions, and also performs the required virtualization processing. The pseudo host mode end unit 104 is a program code that performs the required post-processing when the virtual sensitive instruction exception handler 111 has executed the extension instructions for resetting the guest OS, and then returns control to the actual guest OS 120.

The virtualization support function control unit 105 controls the shifting between the host mode and guest mode in the CPU 11, and also the saving and restoration of execution states that accompany the shifting. The guest state save control unit 106 controls the saving and restoration of multiple execution states in the guest mode, which here are the execution states between the guest OS state 25a and the virtual machine monitor state 25b.

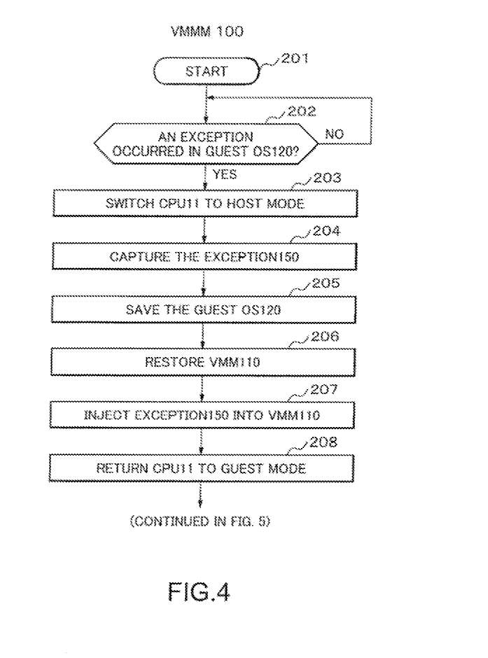

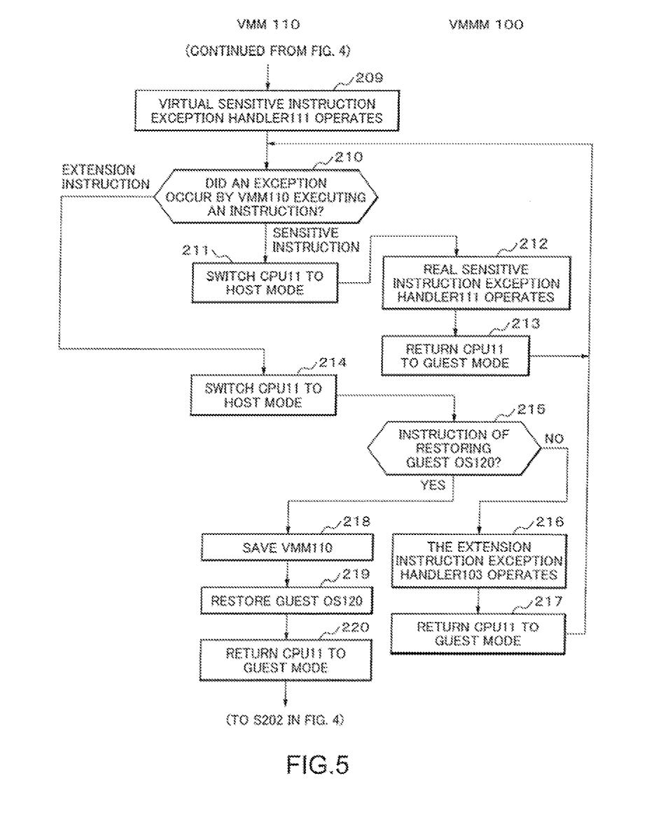

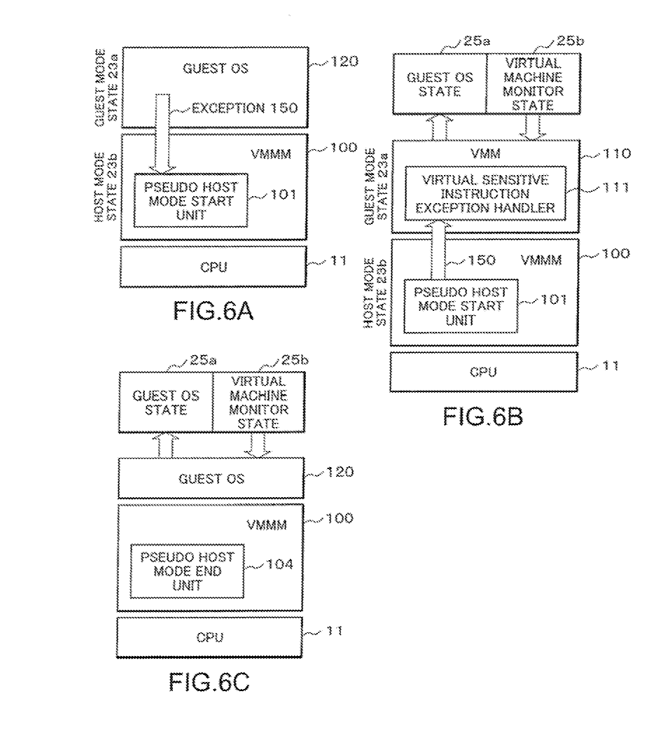

FIG. 4 and FIG. 5 are flow charts showing the processing executed on the VMMM 100 and the VMM 110 when an exception occurs by executing a sensitive instruction. FIG. 6 is an overview diagram showing the execution state shifting in the processing shown in FIG. 4. At the starting point of FIG. 4, the CPU 11 is in guest mode as shown in FIG. 6A, and in a state where the guest OS 120 is being executed.

When the guest OS 120 starts up (S201), the CPU 11 sets to a state a waiting an exception generated from the guest OS 120 (S202). When an exception 150 occurs from the guest OS 120, then the CPU 11 itself switches to host mode and shifts to a state for executing the VMMM 100 (S203). Next, the pseudo host mode start unit 101 captures the generated exception 150 (S204), and the guest state save control unit 106 saves the execution state of guest OS 120 in the guest OS state 25a (S205), and the guest state save control unit 106 restores the execution state of VMM 110 from the virtual machine monitor state 25b (S206).

Next the pseudo host mode start unit 101 injects the exception 150 acquired in S204 into the restored VMM 110 (S207). The virtualization support function control unit 105 then returns the CPU 11 to the guest mode (S208).

The CPU 11 is in guest mode at this time and in a state where executing the VMM 110. The virtual sensitive instruction exception handler 111 is executed in the VMM 110 where the exception 150 captured in S204 was injected (S209). As shown in FIG. 6B, the VMM 110 is executed as if the VMM 110 directly receives an exception 150 for a sensitive instruction from the guest OS 120, and the corresponding processing can be performed.

Here when an exception 150 occurs by the VMM 110 executing a sensitive instruction or an extended instruction (S210), the CPU 11 itself switches to host mode if the exception is caused by a sensitive instruction (S211). And the real sensitive instruction exception handler 102 executes the required exception processing (S212), then the virtualization support function control unit 105 again returns the CPU 11 to the guest mode (S213).

If the exception was caused by an extended instruction, the CPU 11 itself switches to host mode (S214). And then the extension instruction exception handler 103 decides if the extension instruction causing the exception is the extension instruction for restoring the guest OS (for executing the guest OS) or not (S215). If not an extension instruction for restoring the guest OS, the extension instruction exception handler 103 executes the required exception processing (S216), then the virtualization support function control unit 105 again returns the CPU 11 to the guest mode (S217).

If an extension instruction for restoring the guest OS, then the pseudo host mode end unit 104 controls the guest state save control unit 106 to save the execution state of VMM 110 in the virtual machine monitor state 25b (S218), and restores the execution state of guest OS 120 from the guest OS state 25a (S219). The virtualization support function control unit 105 then returns the CPU 11 to guest mode (S220), and returns the state in S202 of FIG. 4. In this way, the CPU 11 returns to the state where guest OS 120 is executed in the guest mode as shown in FIG. 6C.

In the above, in an environment such that the VMM 110 is further virtualized by VMMM 100, it is possible to execute a series of processing that the VMM 110 captures and executes processing the exception generated in the execution state of the guest OS 120 without programs. In this case, the VMM 110 and the guest OS 120 do not include special operations to respond to this type of environment and so an already existing VMM 110 and the guest OS 120 can be used unchanged. Moreover, the virtualization support function of the related art possessing only a two-stage virtualization privileged mode can achieve a simulated type operation equivalent to a special hardware containing a three-stage virtualization privileged mode so that the hardware of the related art can be utilized without changes.

### Second Exemplary Embodiment

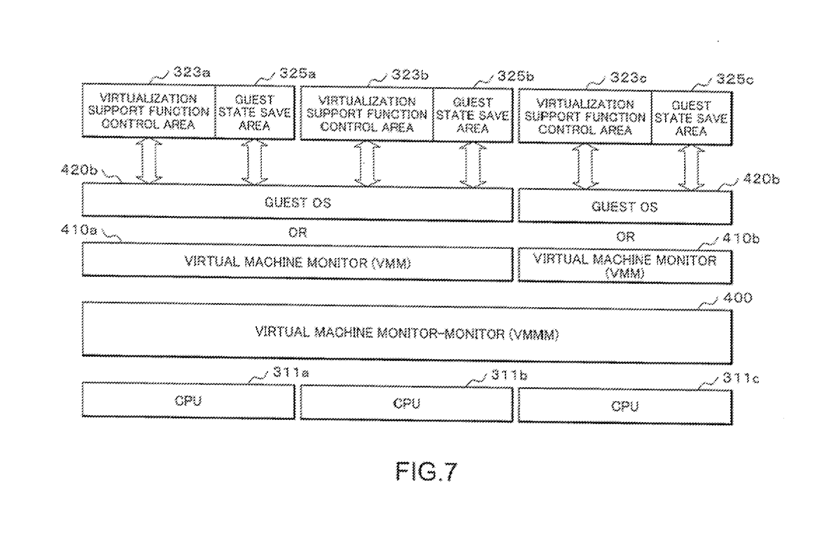

FIG. 7 is a conceptual diagram showing the structure of the software in the second exemplary embodiment of this invention. The hardware for the second exemplary embodiment of this invention contains multiple CPU 311a-311c, and virtualization support function control areas 323a-323c matching each CPU, and a guest state save areas 325a-325c. Other than these points (above components) the hardware of the second exemplary embodiment is identical to the hardware of the first exemplary embodiment described in FIG. 1 and FIG. 2 so a detailed description is omitted.

The virtual machine monitor-monitor (VMMM) 400 controls all of these multiple CPUs 311a-311c, virtualization support function control areas 323a-323c and the guest state save areas 325a-325c. The multiple virtual machine monitor (VMM) 410a and 410b and multiple guest OS 420a and 420b are subdivided by the CPUs 311a-311c boundaries and executed simultaneously. Two CPUs, 311a and 311b executes the 410a and the guest OS 420a. One CPU, 311c executes the VMM 410b and the guest OS 420b.

The structure of the VMMM 400, VMM 410a and 410b, and the guest OSs 420a and 420b are respectively identical to the VMMM 100, the VMM 110 and the guest OS 120 of the first exemplary embodiment of this invention. Therefore, only those points differing from the first exemplary embodiment are described next and a detailed description of all other points is omitted.

When the VMMM 400 captures an exception generated by any of the guest OSs 420a and 420b executing a sensitive instruction, the VMMM 400 detects which of the CPUs 311a-311c generated the exception. The VMM 400 then selects the guest state save area and the virtualization support function control area for the corresponding CPU where the exception was detected, and performs the same processing as in the first exemplary embodiment of this invention.

The operation is described next while referring to FIG. 7.

After the guest OS 420a executes a sensitive instruction for the CPU 311a, the VMMM 400 utilizes the virtualization support function control area 323a, and the guest state save area 325a corresponding to the CPU 311a to restore the execution status of the VMM 410a, and injects the exception generated in the execution state of the guest OS 420a.

After the guest OS 420a executes a sensitive instruction for the CPU 311b, the VMMM 400 utilizes the virtualization support function control area 323b, and the guest state save area 325b corresponding to the CPU 311b to restore the execution status of the VMM 410a, and injects the exception generated in the execution state of the guest OS 420a.

After the guest OS 420b executes a sensitive instruction for the CPU 311c, the VMMM 400 utilizes the virtualization support function control area 323c, and the guest state save area 325c corresponding to the CPU 311c to restore the execution status of the VMM 410b, and injects the exception generated in the execution state of the guest OS 420b.

In this way, a long with the effect of the first exemplary embodiment, the second exemplary embodiment can easily be extended and applied even to multiprocessor environments containing multiple CPU assumed as the environment where the virtual machine is built.

This invention is not limited to the embodiments shown in the drawings and needless to say can employ all manner of structures of the known art, providing the effect of the invention is obtained.

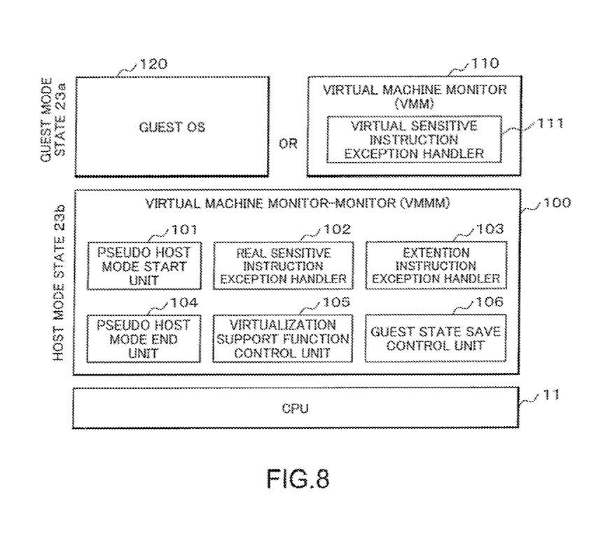

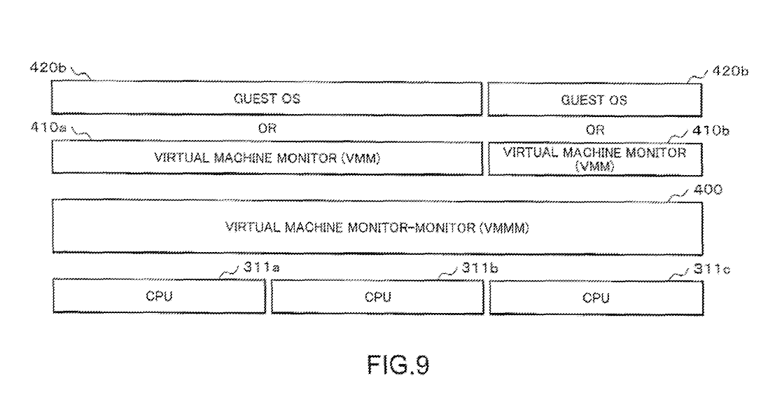

While in the first and second exemplary embodiment, it is acceptable that said main memory 15 does not have virtualization support function control area 23 and guest state save area 25. In this case, for example, it acceptable that information stored in virtualization support function control area 23 and guest state save area 25 is stored in an external memory and computer 10 accesses to the external memory if necessary. FIG. 8 is an overall concept view showing the structure of the software in the case that main memory 15 does not have virtualization support function control area 23 and guest state save area 25 in the first exemplary embodiment. FIG. 9 is an overall concept view showing the structure of the software in the case that main memory 15 does not have virtualization support function control area 23 and guest state save area 25 in the second exemplary embodiment.

While this invention has been described in conjunction with the preferred embodiments described above, it will now be possible for those skilled in the art to put this invention into practice in various other manners.

What is claimed is:

1. A virtualized computer comprising:
a CPU which shifts between a host mode and a guest mode, executing either a guest OS or a virtual machine monitor (VMM) in said guest mode and executing a virtual machine monitor-monitor (VMMM) in said host mode,
wherein said VMM monitors said guest OS and said VMMM monitors said VMM.

2. The virtualized computer according to claim 1,
wherein, when a first exception occurs in the execution state of said guest OS, said CPU shifts from said guest mode to said host mode and executes said VMMM,
when said VMMM captures said first exception, said VMMM executes an inject processing to inject said captured first exception into said VMM, and
after said inject processing, said CPU shifts from said host mode to said guest mode and executes said VMM.

3. The virtualized computer according to claim 2, further comprising:
a memory which stores information indicating an execution state of said host mode and said guest mode,
wherein said CPU shifts between said guest mode and said host mode based on said information.

4. The virtualized computer according to claim 3, further comprising a plurality of CPUS, and
wherein said memory stores said information of each CPU, and
said CPU shifts between said host mode and said guest mode based on said information corresponded to said CPU where said first exception occurs.

5. The virtualized computer according to claim 3,
wherein said information includes execution state information of said guest OS and said VMM, and
after saving said execution state of said guest OS on said memory and restoring said execution state of said VMM from said memory, said VMMM executes said inject processing to said restored VMM.

6. The virtualized computer according to claim 4,
wherein said information includes execution state information of said guest OS and said VMM, and
after saving said execution state of said guest OS on said memory and restoring said execution state of said VMM from said memory, said VMMM executes said inject processing to said restored VMM.

7. The virtualized computer according to claim 5,
wherein, when a second exception occurs in the execution state of said VMM, said CPU shifts from said guest mode to said host mode based on said information and executes said VMMM and said VMMM executes processing for said second exception.

8. The virtualized computer according to claim 6,
wherein, when a second exception occurs in the execution state of said VMM, said CPU shifts from said guest mode to said host mode based on said information and executes said VMMM and said VMMM executes processing for said second exception.

9. The virtualized computer according to claim 7,
wherein, if said second exception is based on an instruction to execute said guest OS, said VMMM restores said execution state of said guest OS and said CPU shifts from said host mode to said guest mode and executes said guest OS.

10. The virtualized computer according to claim 8,
wherein, if said second exception is based on an instruction to execute said guest OS, said VMMM restores said execution state of said guest OS and said CPU shifts from said host mode to said guest mode and executes said guest OS.

11. The virtualized computer according to claim 9,
wherein, if the second exception is not based on an instruction to execute said guest OS, said VMMM captures said second exception and executes processing for said captured second exception.

12. The virtualized computer according to claim 10,
wherein, if the second exception is not based on an instruction to execute said guest OS, said VMMM captures said second exception and executes processing for said captured second exception.

13. A monitoring method of a virtualized computer which shifts between a host mode and a guest mode, comprising:
executing either a guest OS or a virtual machine monitor (VMM) in said guest mode and executing a virtual machine monitor-monitor (VMMM) in said host mode, and
said VMMM monitoring said VMM which monitors said guest OS.

14. The monitoring method of said virtualized computer according to claim 13, further comprising:
shifting from said guest mode to said host mode and executing said VMMM, when a first exception occurs in the execution state of said guest OS,
when said VMMM captures said first exception, said VMMM executing an inject processing to inject said captured first exception into said VMM, and
shifting from said host mode to said guest mode and executing said VMM after said VMMM executing said inject processing.

15. The monitoring method of said virtualized computer according to claim 14, further comprising:
said computer including a CPU,
said computer storing information indicating an execution state of said host mode and said guest mode, and
in said shifting, said CPU shifting between said guest mode and said host mode based on said information.

16. The monitoring method of said virtualized computer according to claim 15, further comprising:
said computer including a plurality of CPUs,
said computer storing said information of each CPU, and
in said shifting, said CPU shifting between said host mode and said guest mode based on said information corresponded to said CPU where said first exception occurs.

17. The monitoring method of said virtualized computer according to claim 15, further comprising:
said information including execution state information of said guest OS and said VMM, and
said VMMM executing said inject processing to said restored VMM after saving said execution state of said guest OS on said memory and restoring said execution state of said VMM from said memory.

18. The monitoring method of said virtualized computer according to claim 16, further comprising:
said information including execution state information of said guest OS and said VMM, and
said VMMM executing said inject processing to said restored VMM after saving said execution state of said guest OS on said memory and restoring said execution state of said VMM from said memory.

19. The monitoring method of said virtualized computer according to claim 17, further comprising:
shifting from said guest mode to said host mode based on said information and executing said VMMM when a second exception occurs in the execution state of said VMM, and
said VMMM executing processing for said second exception.

20. The monitoring method of said virtualized computer according to claim 18, further comprising:
shifting from said guest mode to said host mode and executing said VMMM when a second exception occurs in the execution state of said VMM,
said VMMM executing processing for said second exception, and
in said shifting when said second exception occurs, said CPU shifting between said host mode and said guest mode based on said information corresponded to said CPU where said second exception occurs.

21. The monitoring method of said virtualized computer according to claim 19, further comprising:
in said executing said processing for said second exception, if said second exception is based on an instruction to execute said guest OS, said VMMM restoring said execution state of said guest OS and said CPU shifting from said host mode to said guest mode and executing said guest OS.

22. The monitoring method of said virtualized computer according to claim 20, further comprising:
in said executing processing for said second exception, if said second exception is based on an instruction to execute said guest OS, said VMMM restoring said execution state of said guest OS and said CPU shifting from said host mode to said guest mode and executing said guest OS.

23. The monitoring method of said virtualized computer according to claim 21, further comprising:
in said executing processing for said second exception, if the second exception is not based on an instruction to execute said guest OS, said VMMM capturing said second exception and executing processing for said captured second exception.

24. The monitoring method of said virtualized computer according to claim 22, further comprising:
in said executing processing for said second exception, if the second exception is not based on an instruction to execute said guest OS, said VMMM capturing said second exception and executing processing for said captured second exception.

25. A computer readable medium recording thereon a program for enabling a computer to execute a monitoring method of a virtualized computer which shifts between a host mode and a guest mode, the method comprising:
executing either a guest OS or a virtual machine monitor (VMM) in said guest mode and executing a virtual machine monitor-monitor (VMMM) in said host mode, and
said VMMM monitoring said VMM which monitors said guest OS.

26. The computer readable medium according to claim 25, the method comprising:
shifting from said guest mode to said host mode and executing said VMMM, when a first exception occurs in the execution state of said guest OS,
when said VMMM captures said first exception, said VMMM executing an inject processing to inject said captured first exception into said VMM, and
shifting from said host mode to said guest mode and executing said VMM after said VMMM executing said inject processing.

27. The computer readable medium according to claim 26, the method further comprising:
said computer including a CPU,
said computer storing information indicating an execution state of said host mode and said guest mode, and
in said shifting, said CPU shifting between said guest mode and said host mode based on said information.

28. The computer readable medium according to claim 27, the method further comprising:
said computer including a plurality of CPUs,
said computer storing said information of each CPU, and
in said shifting, said CPU shifting between said host mode and said guest mode based on said information corresponded to said CPU where said first exception occurs.

29. The computer readable medium according to claim 27, the method further comprising:
said information including execution state information of said guest OS and said VMM, and
said VMMM executing said inject processing to said restored VMM after saving said execution state of said guest OS on said memory and restoring said execution state of said VMM from said memory.

30. The computer readable medium according to claim 28, the method further comprising:
said information including execution state information of said guest OS and said VMM, and
said VMMM executing said inject processing to said restored VMM after saving said execution state of said guest OS on said memory and restoring said execution state of said VMM from said memory.

31. The computer readable medium according to claim 29, the method further comprising:
shifting from said guest mode to said host mode based on said information and executing said VMMM when a second exception occurs in the execution state of said VMM, and
said VMMM executing processing for said second exception.

32. The computer readable medium according to claim 30, the method further comprising:
shifting from said guest mode to said host mode and executing said VMMM when a second exception occurs in the execution state of said VMM,
said VMMM executing processing for said second exception, and
in said shifting when said second exception occurs, said CPU shifting between said host mode and said guest mode based on said information corresponded to said CPU where said second exception occurs.

33. The computer readable medium according to claim 31, the method further comprising:
in said executing said processing for said second exception, if said second exception is based on an instruction to execute said guest OS, said VMMM restoring said execution state of said guest OS and said CPU shifting from said host mode to said guest mode and executing said guest OS.

34. The computer readable medium according to claim 32, the method further comprising:
in said executing processing for said second exception, if said second exception is based on an instruction to execute said guest OS, said VMMM restoring said execution state of said guest OS and said CPU shifting from said host mode to said guest mode and executing said guest OS.

35. The computer readable medium according to claim 33, the method further comprising:
in said executing processing for said second exception, if the second exception is not based on an instruction to execute said guest OS, said VMMM capturing said second exception and executing processing for said captured second exception.

36. The computer readable medium according to claim 34, the method further comprising:
in said executing processing for said second exception, if the second exception is not based on an instruction to execute said guest OS, said VMMM capturing said second exception and executing processing for said captured second exception.

37. A virtualized computer comprising:
a means for shifting between a host mode and a guest mode, executing either a guest OS or a virtual machine monitor (VMM) in said guest mode and executing a virtual machine monitor-monitor (VMMM) in said host mode,
wherein said VMM monitors said guest OS and said VMMM monitors said VMM.
